(19) United States
(12) Patent Application Publication
(10) Pub. No.: US 2016/0224400 A1
(43) Pub. Date: Aug. 4, 2016

(54) AUTOMATIC ROOT CAUSE ANALYSIS FOR DISTRIBUTED BUSINESS TRANSACTION

(71) Applicant: AppDynamics Inc., San Francisco, CA (US)

(72) Inventors: Hatim Shafique, Redwood City, CA (US); Arpit Patel, Fremont, CA (US); Abey Tom, Woodbridge, NJ (US)

(21) Appl. No.: 14/609,311

(22) Filed: Jan. 29, 2015

(51) Int. Cl. G06F 11/07

(52) U.S. Cl. CPC G06F 11/079; G06F 11/0709; G06F 11/0751

(57) ABSTRACT

A system that automatically provides a root cause analysis for performance issues associated with an application, a tier of nodes, an individual node, or a business transaction. One or more distributed business transactions are monitored and data obtained from the monitoring is provided to a controller. The controller analyzes the data to identify performance issues with the business transaction, tiers of nodes, individual nodes, methods, and other components that perform or affect the business transaction performance. Once the performance issues are identified, the cause of the issues is determined as part of a root cause analysis.

### BACKGROUND OF THE INVENTION

The World Wide Web has expanded to provide web services faster to consumers. For companies that rely on web services to implement their business, it is very important to provide reliable web services. Many companies that provide web services utilize application performance management products to keep their web services running well.

Typically, when trying to determine a performance issue with an application, reports of data must be reviewed manually. When performed manually, identifying the precise cause of a performance issue for an application can be very difficult to determine, not to mention the difficulty of identifying what methods or other causes are the primary factors for the application performing badly. This problem makes most application performance management applications difficult to obtain value from without a very experienced administrator, or sometimes even an engineer, spending valuable time reviewing monitoring data and reports of performance data.

What is needed is an improved method for reporting performance issues.

### SUMMARY OF THE CLAIMED INVENTION

The present technology, roughly described, automatically provides a root cause analysis for performance issues associated with an application, a tier of nodes, an individual node, or a business transaction. One or more distributed business transactions are monitored and data obtained from the monitoring is provided to a controller. The controller analyzes the data to identify performance issues with the business transaction, tiers of nodes, individual nodes, methods, and other components that perform or affect the business transaction performance. Once the performance issues are identified, the cause of the issues is determined as part of a root cause analysis.

Information regarding the root cause analysis can be provided automatically without sorting through large amounts of data. The root cause analysis may be provided through an interface as metric information, poorly performing methods, poorly performing exit calls, errors, and snapshots that involve the performance issue. The data and root cause analysis is provided in real time to an administrator through a series of user interfaces.

An embodiment may include a method for determining root cause analysis. A selection is received for identifying a controller by a server. Performance data is accessed by the server. The performance data is provided by the controller and generated from monitoring distributed business transactions. The monitoring performed by agents that report data to the controller. A performance issue is identified by the server based on the reported data. A cause analysis is automatically performed for performance issues with distributed transactions analyzed by the controller.

An embodiment may include a system for performing a root cause analysis. The system may include a processor, a memory and one or more modules stored in memory and executable by the processor. When executed, the one or more modules may identify a controller by a server and access performance data by a server. The performance data may be provided by the controller and generated from monitoring distributed business transactions. The monitoring may be performed by agents that report data to the controller. The method may identify a performance issue by the server, wherein the performance issue is based on the reported data. A cause analysis may be automatically performed for performance issues with distributed transactions analyzed by the controller.

### BRIEF DESCRIPTION OF THE DRAWINGS

FIG. 1 is a block diagram of a system for automatically performing a root cause analysis.

FIG. 2 is a block diagram of a controller.

FIG. 3 is a method for automatically performing a root cause analysis.

FIG. 4 is a method for monitoring distributed servers and identifying performance issues.

FIG. 5 is a method for providing a tiered analysis.

FIG. 6 is an exemplary user interface providing an application performance report.

FIG. 7 is an exemplary user interface providing a tier analysis.

FIG. 8 is an exemplary user interface for providing a root cause analysis with metric data.

FIG. 9 is an exemplary user and interface for providing a root cause analysis with method data.

FIG. 10 is an exemplary user interface for providing a root cause analysis based on exit calls.

FIG. 11 is an exemplary user interface for providing cause analysis based on errors.

FIG. 12A is an exemplary user interface for providing a root cause analysis based on the snapshots.

FIG. 12B is an exemplary user interface including a call graph and a snapshot.

FIG. 13 is a block diagram of a system for implementing the present technology.

### DETAILED DESCRIPTION

The present technology, roughly described, automatically provides a root cause analysis for performance issues associated with an application, a tier of nodes, an individual node, or a business transaction. One or more distributed business transactions are monitored and data obtained from the monitoring is provided to a controller. The controller analyzes the data to identify performance issues with the business transaction, tiers of nodes, individual nodes, methods, and other components that perform or affect the business transaction performance. Once the performance issues are identified, the cause of the issues is determined as part of a root cause analysis.

Information regarding the root cause analysis can be provided automatically without sorting through large amounts of data. The root cause analysis may be provided through an interface as metric information, poorly performing methods, poorly performing exit calls, errors, and snapshots that involve the performance issue. The data and root cause analysis is provided in real time to an administrator through a series of user interfaces.

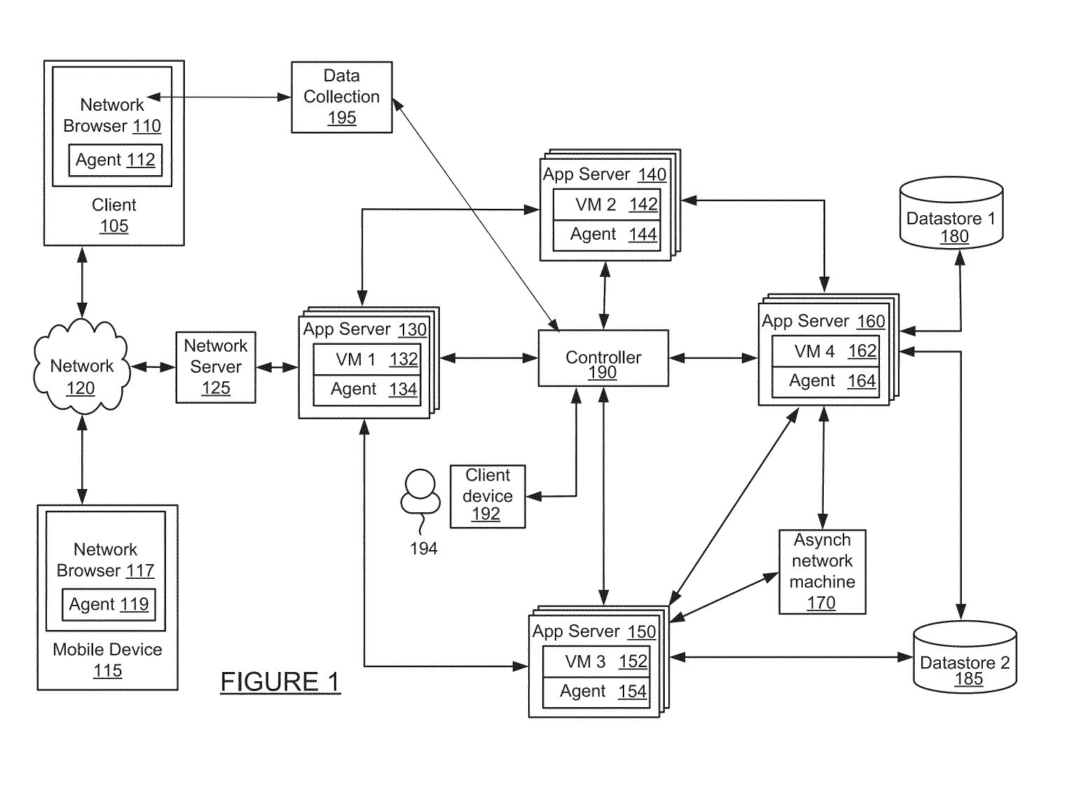

FIG. 1 is a block diagram of a system for automatically performing a root cause analysis. System 100 of FIG. 1 includes client device 105 and 192, mobile device 115, network 120, network server 125, application servers 130, 140, 150 and 160, asynchronous network machine 170, data stores 180 and 185, and controller 190.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120. Mobile device 115 is connected to network 120 and may be implemented as a portable device suitable for receiving content over a network, such as for example a mobile phone, smart phone, tablet computer or other portable device. Both client device 105 and mobile device 115 may include hardware and/or software configured to access a web service provided by network server 125.

Network 120 may facilitate communication of data between different servers, devices and machines. The network may be implemented as a private network, public network, intranet, the Internet, a Wi-Fi network, cellular network, or a combination of these networks.

Network server 125 is connected to network 120 and may receive and process requests received over network 120. Network server 125 may be implemented as one or more servers implementing a network service. When network 120 is the Internet, network server 125 may be implemented as a web server. Network server 125 and application server 130 may be implemented on separate or the same server or machine.

Application server 130 communicates with network server 125, application servers 140 and 150, controller 190. Application server 130 may also communicate with other machines and devices (not illustrated in FIG. 1). Application server 130 may host an application or portions of a distributed application and include a virtual machine 132, agent 134, and other software modules. Application server 130 may be implemented as one server or multiple servers as illustrated in FIG. 1, and may implement both an application server and network server on a single machine.

Application server 130 may include applications in one or more of several platforms. For example, application server 130 may include a Java application, .NET application, PHP application, C++ application, or other application. Particular platforms are discussed below for purposes of example only.

Virtual machine 132 may be implemented by code running on one or more application servers. The code may implement computer programs, modules and data structures to implement, for example, a virtual machine mode for executing programs and applications. In some embodiments, more than one virtual machine 132 may execute on an application server 130. A virtual machine may be implemented as a Java Virtual Machine (JVM). Virtual machine 132 may perform all or a portion of a business transaction performed by application servers comprising system 100. A virtual machine may be considered one of several services that implement a web service.

Virtual machine 132 may be instrumented using byte code insertion, or byte code instrumentation, to modify the object code of the virtual machine. The instrumented object code may include code used to detect calls received by virtual machine 132, calls sent by virtual machine 132, and communicate with agent 134 during execution of an application on virtual machine 132. Alternatively, other code may be byte code instrumented, such as code comprising an application which executes within virtual machine 132 or an application which may be executed on application server 130 and outside virtual machine 132.

In embodiments, application server 130 may include software other than virtual machines, such as for example one or more programs and/or modules that processes AJAX requests.

Agent 134 on application server 130 may be installed on application server 130 by instrumentation of object code, downloading the application to the server, or in some other manner. Agent 134 may be executed to monitor application server 130, monitor virtual machine 132, and communicate with byte instrumented code on application server 130, virtual machine 132 or another application or program on application server 130. Agent 134 may detect operations such as receiving calls and sending requests by application server 130 and virtual machine 132. Agent 134 may receive data from instrumented code of the virtual machine 132, process the data and transmit the data to controller 190. Agent 134 may perform other operations related to monitoring virtual machine 132 and application server 130 as discussed herein. For example, agent 134 may identify other applications, share business transaction data, aggregate detected runtime data, and other operations.

Agent 134 may be a Java agent, .NET agent, PHP agent, or some other type of agent, for example based on the platform which the agent is installed on. Additionally, each application server may include one or more agents.

Each of application servers 140, 150 and 160 may include an application and an agent. Each application may run on the corresponding application server or a virtual machine. Each of virtual machines 142, 152 and 162 on application servers 140-160 may operate similarly to virtual machine 132 and host one or more applications which perform at least a portion of a distributed business transaction. Agents 144, 154 and 164 may monitor the virtual machines 142-162 or other software processing requests, collect and process data at runtime of the virtual machines, and communicate with controller 190. The virtual machines 132, 142, 152 and 162 may communicate with each other as part of performing a distributed transaction. In particular each virtual machine may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. Controller 190 may receive runtime data from each of agents 134-164, associate portions of business transaction data, communicate with agents to configure collection of runtime data, and provide performance data and reporting through an interface. The interface may be viewed as a web-based interface viewable by mobile device 115, client device 105, or some other device. In some embodiments, a client device 192 may directly communicate with controller 190 to view an interface for monitoring data.

Controller 190 may install one or more agents into one or more virtual machines and/or application servers 130. Controller 190 may receive correlation configuration data, such as an object, a method, or class identifier, from a user through client device 192.

Controller 190 may collect and monitor customer usage data collected by agents on customer application servers and analyze the data. The data analysis may include cause analysis of application performance determined to be below a baseline performance for a particular business transaction, tier of nodes, node, or method. The controller may report the analyzed data via one or more interfaces, including but not limited to a user interface providing root cause analysis information.

Data collection server 195 may communicate with client 105, 115 (not shown in FIG. 1), and controller 190, as well as other machines in the system of FIG. 1. Data collection server 195 may receive data associated with monitoring a client request at client 105 (or mobile device 115) and may store and aggregate the data. The stored and/or aggregated data may be provided to controller 190 for reporting to a user.

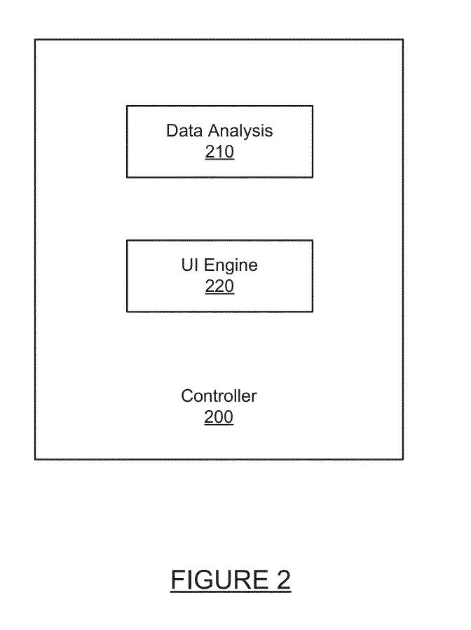

FIG. 2 is a block diagram of a controller. Controller 200 includes data analysis module 210 and UI user interface engine 220. Data analysis module 210 processes data received from external sources such as one or more agents. The analysis module 210 may retrieve data, organize the data into business transactions, tiers and optionally other groupings, determine a baseline for business transaction performance, and identify performance issues within the data. Once a performance issue is determined, whether it is an anomaly, an error, or some other issue, data analysis 210 may perform a root cause analysis. The root cause analysis may determine the root cause of the performance issue. The root cause reporting may include metrics, one or more methods, an error, and exit call, and may include one or more snapshots.

User interface engine 220 may construct and provide user interface providing the root cause analysis data as well as other data to an external computer as a webpage. The interfaces may be provided to an administrator through a network-based content page, such as a webpage, through a desktop application, a mobile application, or through some other program interface.

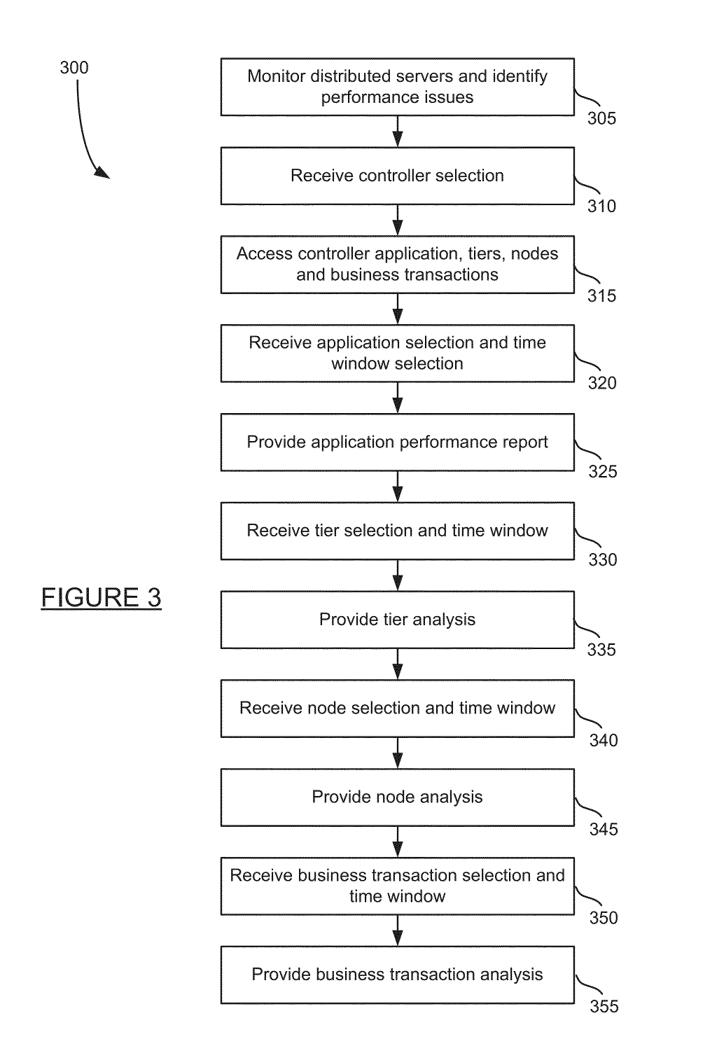

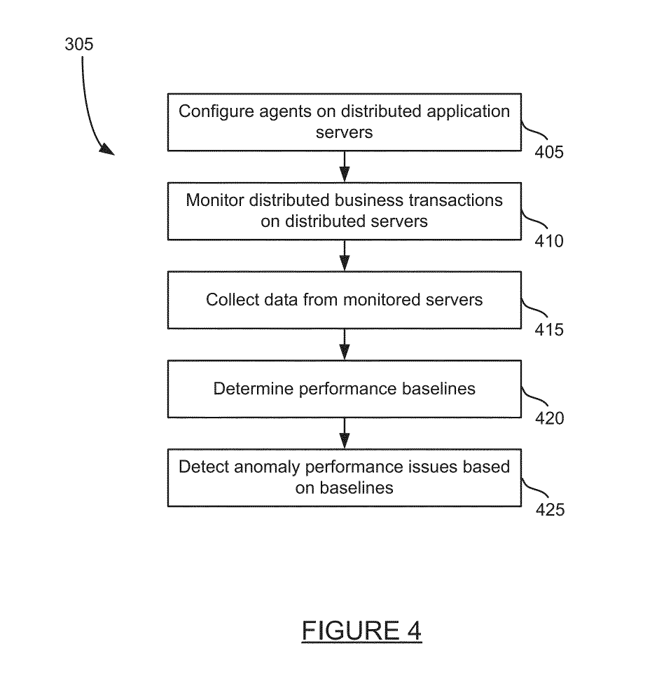

FIG. 3 is a method for automatically performing a root cause analysis. First, distributed servers are monitored and performance issues are identified at step 305. Monitoring distributed servers may be performed by one or more agents installed on each of the servers. Performance issues may be identified using baseline comparison or other techniques. More detail for monitoring distributed servers and identify performance issues as discussed with respect to the method of FIG. 4.

A controller selection may be received at step 310. A user interface may be provided to an administrator to view data regarding performance issues. A controller selection may be received through an interface provided to an administrator. Within the interface, the particular controller is selected so that performance issues associated with the controller can be provided.

Controller application, tier, node and business transaction data may be accessed at step 315. The data may be accessed by the controller in response to receiving the controller selection, as the application, tiers, nodes and business transactions are associated with particular controller. The accessed data may include the name of the applications, tiers, nodes and business transactions associated with the selected controller and may include the data associated with performance (result of analysis of data gathered from monitoring) as well.

An application selection is received along with a time window selection at step 320. The time window selection may include a particular time window for which data should be viewed. The time window may be a number of hours, days, weeks, months, a year, or any other time period.

An application performance report is provided in response to the selection of the application and time window at step 325. The application performance report may be provided through user interface to a user by the controller.

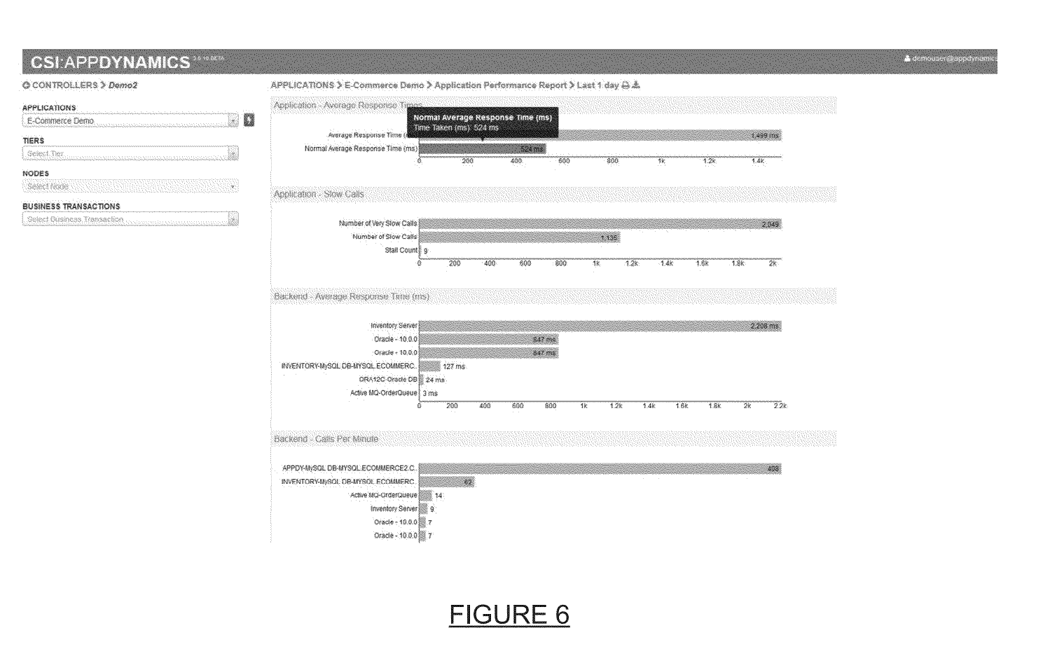

An example of an application performance report is provided in the interface of FIG. 6. An application performance report may include information for an application such as an average response time and slow calls. Information for a backend provided through the application performance report may include the average response time and number of calls per minute handled by the backend. Tier information in the application performance report may include the average response time for the tier, calls per minute made to the tier, a CPU usage percentage, a heap usage percentage, memory usage percentage, and garbage collection time spent. For each metric associated with the application, a graphical representation (such as a bar graph) and numerical information may be shown to represent the data.

A tier selection and time window selection are received at step 330. The tier and time window may be received through the user interface. The options for tiers that are selectable maybe those tiers associated with the selected application. Upon receiving the tier and time window selection, a tier analysis is provided at step 335.

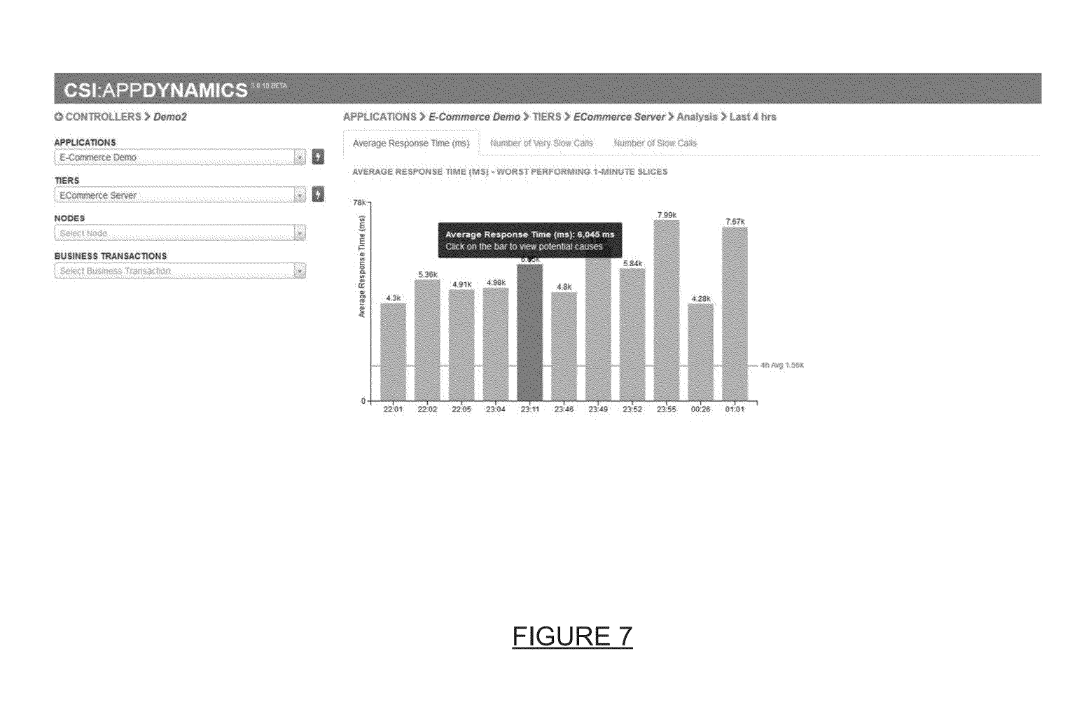

An example of a user interface providing a tier analysis is shown in FIG. 7. The tier analysis may include an average response time in groups consisting of the worst performing one minute slices of time. Hence, the worst average response times for any given minute are provided in the tier analysis. Also provided in the tier analysis are the number of very slow calls and the number of slow calls.

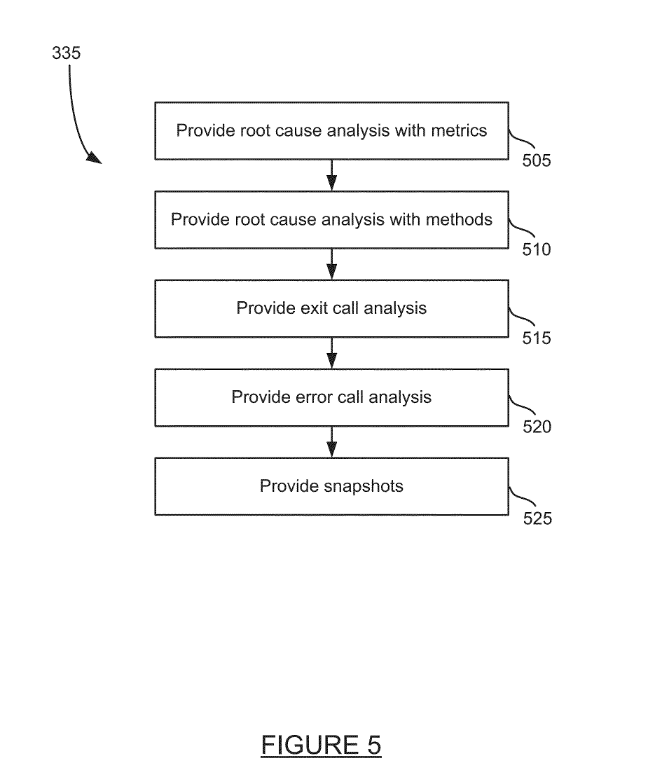

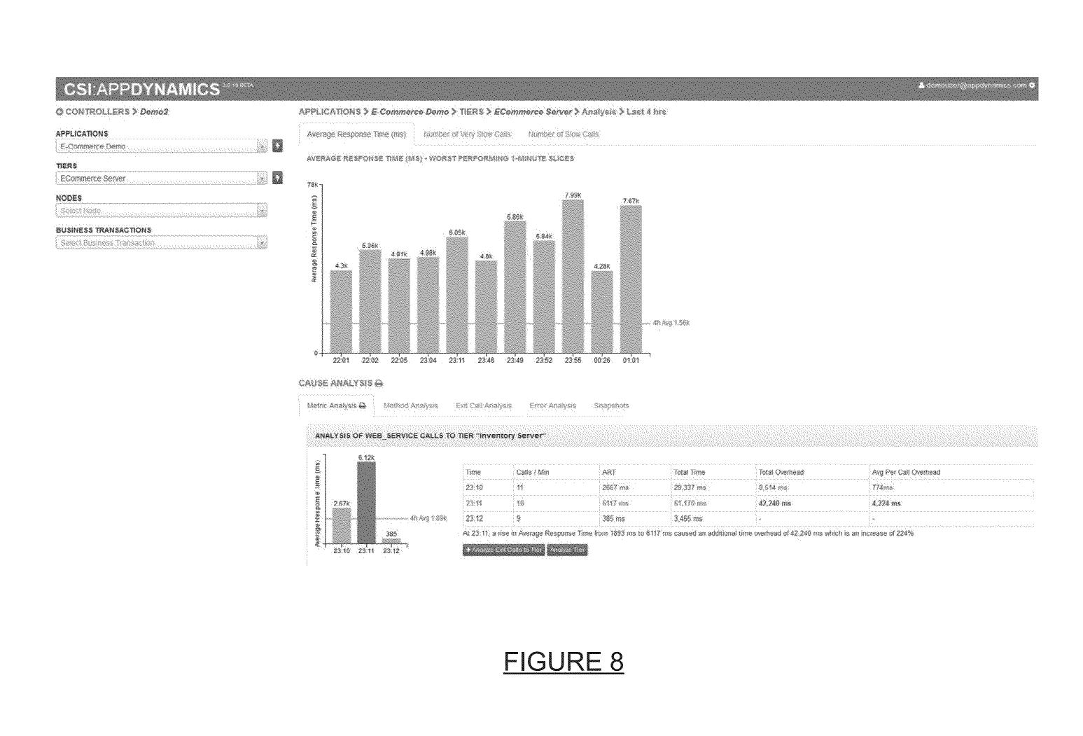

Graphical representations of the slices of data, such as the average response time worst performing one minute slices, may be selected to provide a cause analysis of the particular issue. More detail for providing a root cause analysis for a selected response time is discussed with respect to the method of FIG. 5. FIG. 8 provides a user interface showing a root cause analysis based on metrics.

A node selection may be received along with a time window selection at step 340. The node and time window may be received through user interface similar to receipt of the tier and time window selection at step 330. Once received, a node analysis may be provided at step 345. The node analysis is similar to a tier analysis except that data is provided for a single node rather than a group of node that make up a tier.

A selection of a business transaction and a time window is received at step 350. Business transaction and time window input may be received through the user interface used to receive the tier inputs and note input.

A business transaction analysis is provided at step 355. The business transaction analysis is similar to that for a tier analysis but is only provided for a single business transaction rather than all business transactions handled by a particular tier.

FIG. 4 is a method for monitoring distributed servers and identifying performance issues. The method of FIG. 4 provides more detail for step 305 of the method of FIG. 3. First, agents are configured on distributed application servers at step 405. Configuring agents on distributed application server includes installing an agent, for example by downloading the agent or manually installing an agent, and configuring the agents to monitor particular events (e.g., entry points and exit points) on the server and report data to a controller. Distributed business transactions may be monitored on distributed servers at step 410. The distributed business transactions may be monitored by one or more agents installed on each of the distributed servers. More detail for configuring agents and monitoring business transactions is discussed in U.S. patent application Ser. No. 12/878,919, titled “Monitoring Distributed Web Application Transactions,” filed on Sep. 9, 2010, and U.S. patent application Ser. No. 14/071,503, titled “Propagating a Diagnostic Session for Business Transactions Across Multiple Servers,” filed on Nov. 4, 2013, the disclosures of which are incorporated herein by reference.

Data from the monitored services servers is collected at step 415. Data may be collected by a controller from agents that monitor distributed business transactions on distributed servers. Performance baselines may be determined at step 420. The baselines may be determined for the entire business transaction, performance of a particular method, operation of a tier, a backend, as well as other business transaction components and machines. Once the baselines are determined, an anomaly or other performance issue may be detected based on the baselines at step 425. An anomaly may involve a particular transaction or method taking longer than the baseline range of accepted performance. Other performance issues may involve errors.

FIG. 5 is a method for providing a root cause analysis. After receiving a selection of performance issues for a tier, a user interface may provide root cause analysis data. A cause analysis may be provided with metric information at step 505. This is shown in more detail in the interface of FIG. 8. In the interface of FIG. 8, an analysis of a web service call to a tier called inventory server is shown. A root cause metric analysis displays all metrics and sorts them by the most probably cause of a performance issue. The root cause analysis also calculates the approximate overhead caused by the slowness. Root cause metric analysis shows metrics of time, calls per minute, art, total time, the total overhead and the average per call overhead. Graphical information is also shown for the average response time for particular time slices. An indication is provided within the root cause metric analysis that provides “at 23:11, a rise in average response time from 1893 seconds to 6117 ms cause an additional time overhead 42, 2/42 which is an increase of 224%”. A link is also provided for analyzing exit calls to particular tier as well as analyzing the tier itself.

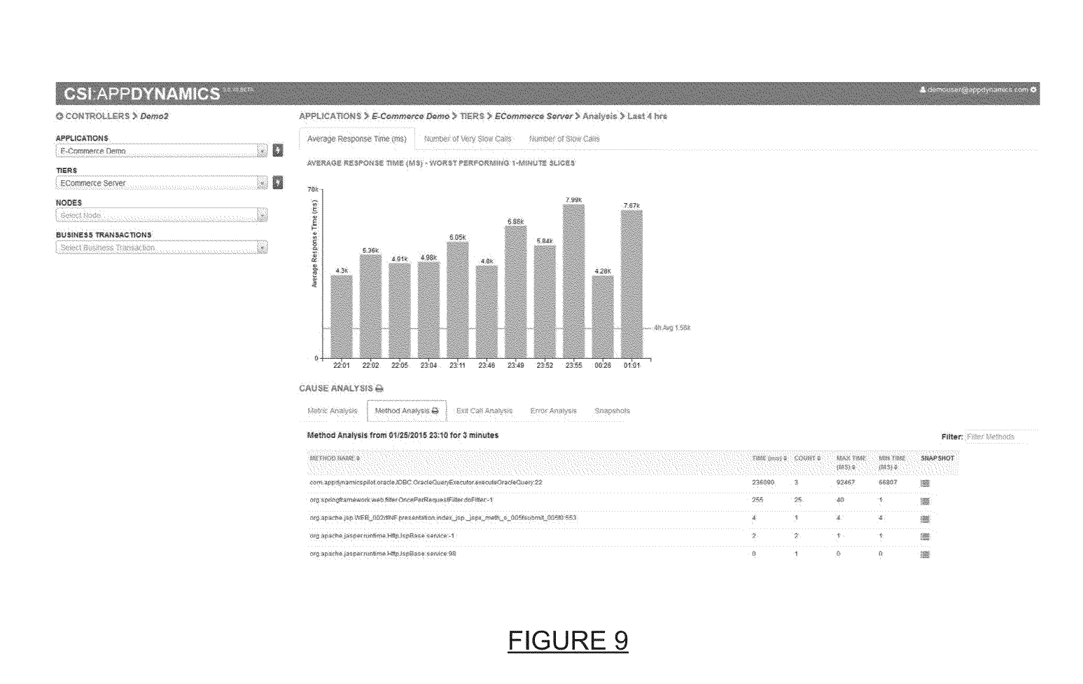

A root cause methods analysis may be provided at step 510. The interface of FIG. 9 provides this as the next tab in the cause analysis interface shown in FIG. 8. The interface of FIG. 9 illustrates a method analysis for three minutes. The method analysis includes data of method name, time, count, maximum time, minimum time, and snapshot data. For each method, the metrics are provided in table format.

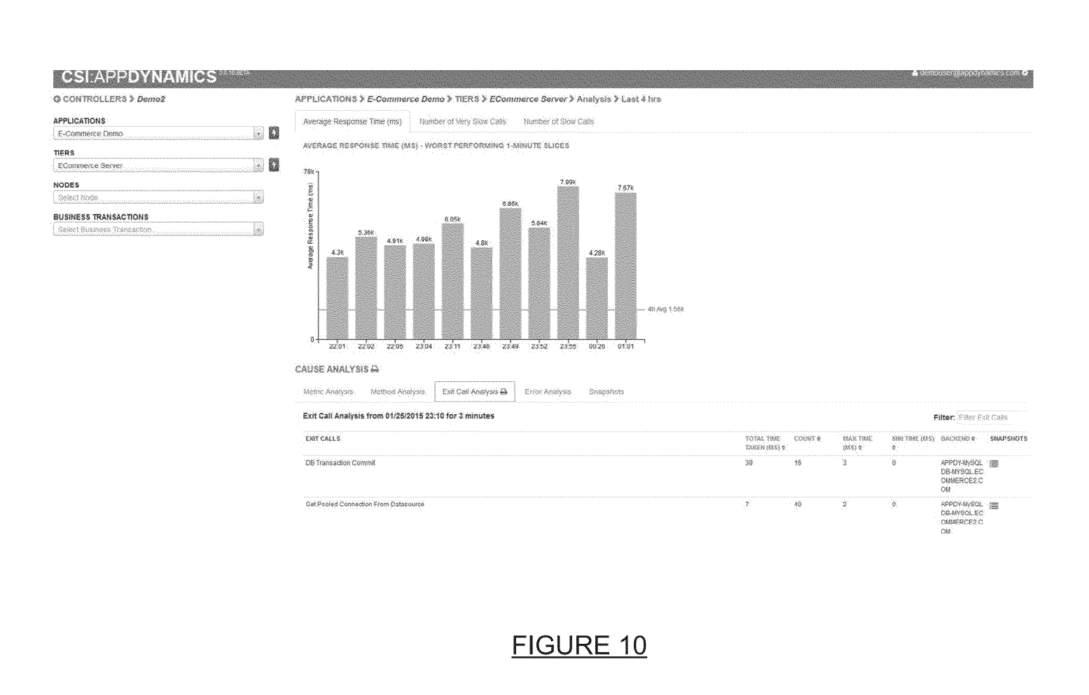

A root analysis of exit calls provided at step by 15. This is illustrated in further detail the interface of FIG. 10. The interface of FIG. 10 provides data of the exit call, the total time taken for the call, the count of the number of calls performed, the maximum time in the minimum time, as well as the backend that received the exit call. Metrics are provided for each of the exit calls for these values.

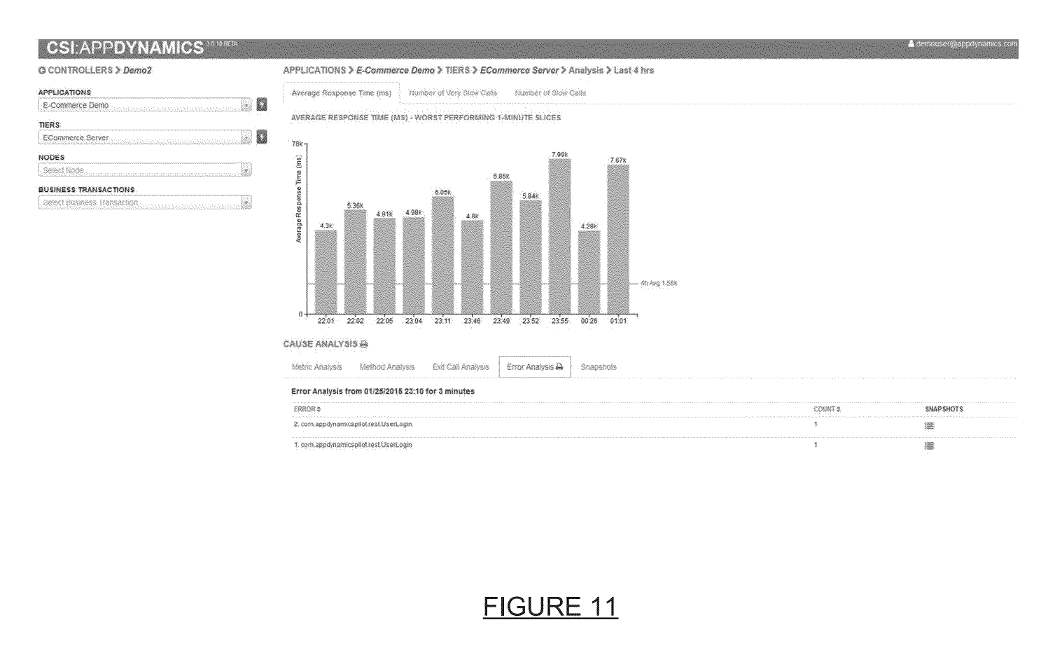

The cause analysis may include an error analysis. An example of the error analysis of step 520 is provided in the interface of FIG. 11. The interface of FIG. 11, error information provided includes the error name and the number of times or count that the error occurred.

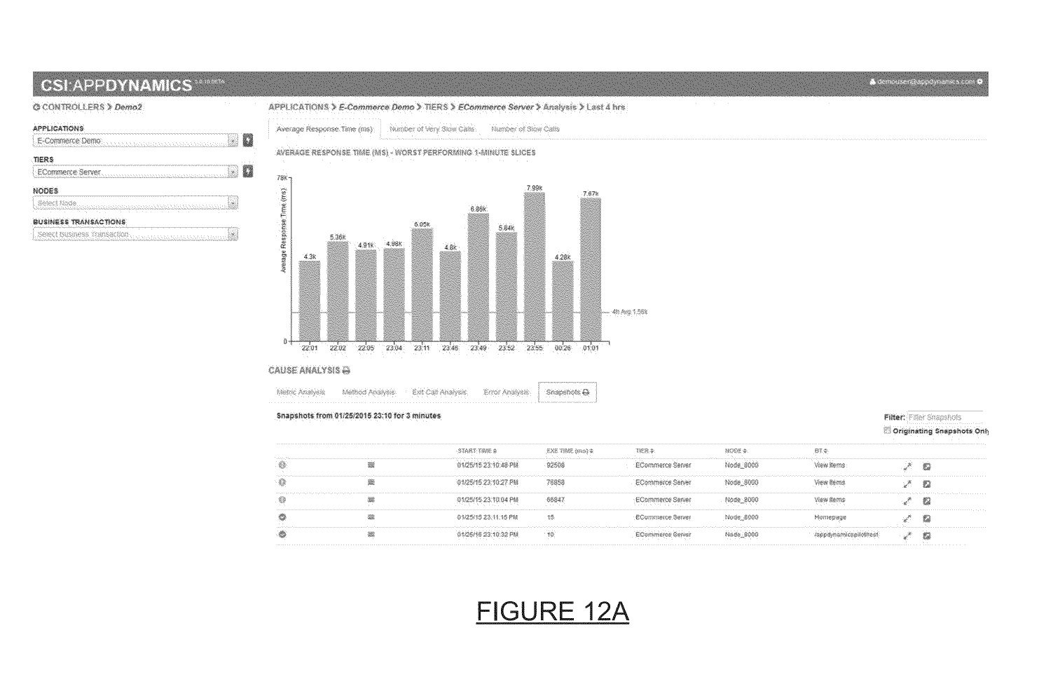

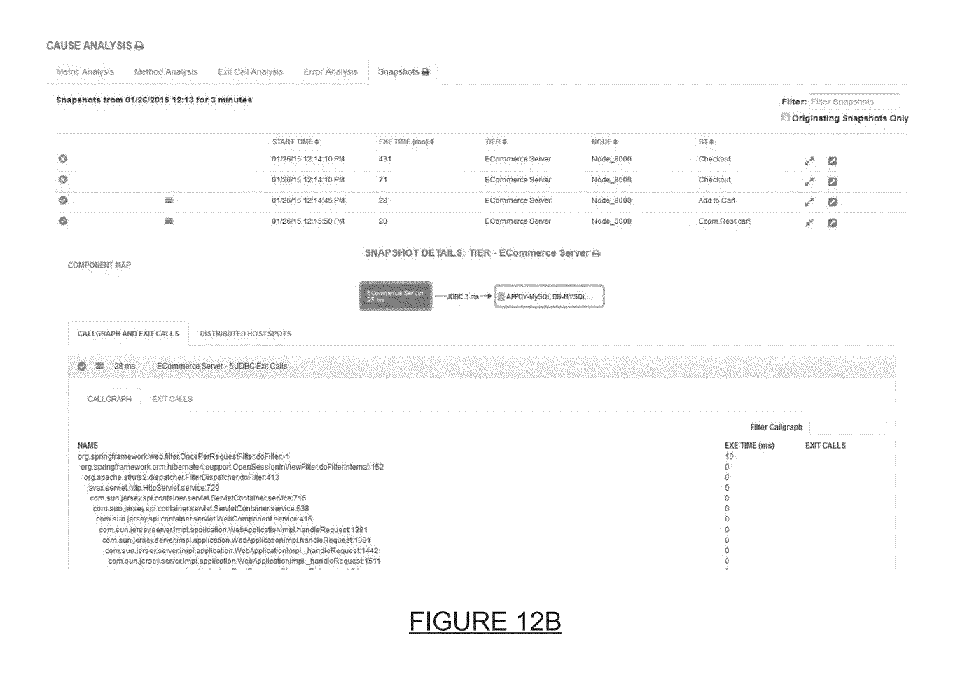

Snapshots may be provided as part of the cause analysis at step 525. An interface with snapshot information is provided in the interface of FIG. 12A. Snapshot information includes a list of available snapshots, a graphic icon indicating the performance of the snapshot, the start time, and execution time, the tier for the snapshot, the note with a particular snapshot, and the business transaction associated with the snapshot. Selection of a an expansion indicator results in viewing of a call graph for the particular snapshot. The call graph shows the list of methods that make up the snapshot in a hierarchical format, indicating the order in which they were performed. When a request for distributed hot spots is received by the interface (by selection of the hot spots tab), the most expensive methods and exit calls in all the correlated snapshots for that business transaction invocation are displayed. For example, if a single invocation of a business transaction spans different tiers and nodes, the distributed hot spot feature provides analysis on all the methods and exit calls at all the nodes. A snapshot and call graph for a call associated with a portion of the distributed business application associated with a selected performance issue are illustrated in FIG. 12B.

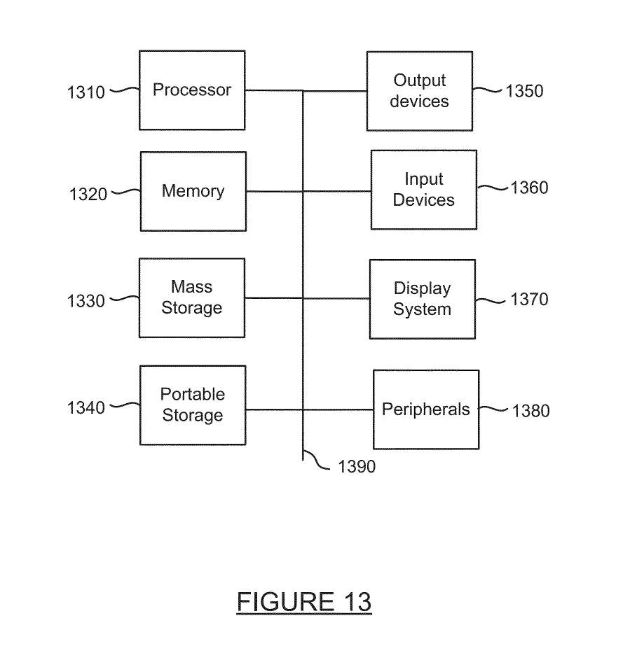

FIG. 13 is a block diagram of a computer system for implementing the present technology. System 500 of FIG. 5 may be implemented in the contexts of the likes of clients 105 and 192, network server 135, application servers 130-160, asynchronous server 170, and data stores 190-185. A system similar to that in FIG. 5 may be used to implement mobile device 115, but may include additional components such as an antenna, additional microphones, and other components typically found in mobile devices such as a smart phone or tablet computer.

The computing system 1300 of FIG. 13 includes one or more processors 1310 and memory 1320. Main memory 1320 stores, in part, instructions and data for execution by processor 1310. Main memory 1320 can store the executable code when in operation. The system 1300 of FIG. 13 further includes a mass storage device 1330, portable storage medium drive(s) 1340, output devices 1350, user input devices 1360, a graphics display 1370, and peripheral devices 1380.

The components shown in FIG. 13 are depicted as being connected via a single bus 1390. However, the components may be connected through one or more data transport means. For example, processor unit 1310 and main memory 1320 may be connected via a local microprocessor bus, and the mass storage device 1330, peripheral device(s) 1380, portable storage device 1340, and display system 1370 may be connected via one or more input/output (I/O) buses.

Mass storage device 1330, which may be implemented with a magnetic disk drive or an optical disk drive, is a non-volatile storage device for storing data and instructions for use by processor unit 1310. Mass storage device 1330 can store the system software for implementing embodiments of the present invention for purposes of loading that software into main memory 1310.

Portable storage device 1340 operates in conjunction with a portable non-volatile storage medium, such as a floppy disk, compact disk or Digital video disc, to input and output data and code to and from the computer system 1300 of FIG. 13. The system software for implementing embodiments of the present invention may be stored on such a portable medium and input to the computer system 1300 via the portable storage device 1340.

Input devices 1360 provide a portion of a user interface. Input devices 1360 may include an alpha-numeric keypad, such as a keyboard, for inputting alpha-numeric and other information, or a pointing device, such as a mouse, a trackball, stylus, or cursor direction keys. Additionally, the system 1300 as shown in FIG. 13 includes output devices 1350. Examples of suitable output devices include speakers, printers, network interfaces, and monitors.

Display system 1370 may include a liquid crystal display (LCD) or other suitable display device. Display system 1370 receives textual and graphical information, and processes the information for output to the display device.

Peripherals 1380 may include any type of computer support device to add additional functionality to the computer system. For example, peripheral device(s) 1380 may include a modem or a router.

The components contained in the computer system 1300 of FIG. 13 are those typically found in computer systems that may be suitable for use with embodiments of the present invention and are intended to represent a broad category of such computer components that are well known in the art. Thus, the computer system 1300 of FIG. 13 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android OS, and other suitable operating systems.

When implementing a mobile device such as smart phone or tablet computer, the computer system 1300 of FIG. 13 may include one or more antennas, radios, and other circuitry for communicating over wireless signals, such as for example communication using Wi-Fi, cellular, or other wireless signals.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for performing root cause analysis, comprising:
identifying a controller by a server;
accessing performance data by the server, the performance data provided by the controller and generated from monitoring distributed business transactions, the monitoring performed by agents that report data to the controller;
identifying by the server a performance issue based on the reported data; and
automatically performing a cause analysis for performance issues with distributed transactions analyzed by the controller.

2. The method of claim 1, wherein the controller is identified from input received through an interface.

3. The method of claim 1, wherein the agents collect runtime data and provided aggregated data to the controller.

4. The method of claim 1, wherein identifying the performance issue includes:
determining a baseline performance level for a portion of a distributed business application; and
comparing performance of the distributed business application portions to the baseline.

5. The method of claim 4, wherein the distributed business transaction portions include an application, a tier, a node, and a method.

6. The method of claim 1, wherein the cause analysis includes a metric analysis of an identified performance issue detected by the controller.

7. The method of claim 1, wherein the cause analysis includes a method analysis of an identified performance issue detected by the controller.

8. The method of claim 1, wherein the cause analysis includes an error analysis of an identified performance issue detected by the controller.

9. The method of claim 1, wherein the cause analysis includes an exit call analysis of an identified performance issue detected by the controller.

10. The method of claim 1, wherein the cause analysis includes a call graph and a snapshot associated with a portion of the distributed business application associated with a selected performance issue.

11. A non-transitory computer readable storage medium having embodied thereon a program, the program being executable by a processor to perform a method for performing root cause analysis, the method comprising:
identifying a controller by a server;
accessing performance data by the server, the performance data provided by the controller and generated from monitoring distributed business transactions, the monitoring performed by agents that report data to the controller;
identifying by the server a performance issue based on the reported data; and
automatically performing a cause analysis for performance issues with distributed transactions analyzed by the controller

12. The non-transitory computer readable storage medium of claim 11, wherein the controller is identified from input received through an interface.

13. The non-transitory computer readable storage medium of claim 11, wherein the agents collect runtime data and provided aggregated data to the controller.

14. The non-transitory computer readable storage medium of claim 11, wherein identifying the performance issue includes:
determining a baseline performance level for a portion of a distributed business application; and
comparing performance of the distributed business application portions to the baseline.

15. The non-transitory computer readable storage medium of claim 14, wherein the distributed business transaction portions include an application, a tier, a node, and a method.

16. The non-transitory computer readable storage medium of claim 11, wherein the cause analysis includes a metric analysis of an identified performance issue detected by the controller.

17. The non-transitory computer readable storage medium of claim 11, wherein the cause analysis includes a method analysis of an identified performance issue detected by the controller.

18. The non-transitory computer readable storage medium of claim 11, wherein the cause analysis includes an error analysis of an identified performance issue detected by the controller.

19. The non-transitory computer readable storage medium of claim 11, wherein the cause analysis includes an exit call analysis of an identified performance issue detected by the controller.

20. The non-transitory computer readable storage medium of claim 11, wherein the cause analysis includes a call graph and a snapshot associated with a portion of the distributed business application associated with a selected performance issue.

21. A server for performing root cause analysis, comprising:
a processor;
a memory; and
one or more modules stored in memory and executable by a processor to identify a controller by a server, access performance data by a server, the performance data provided by the controller and generated from monitoring distributed business transactions, the monitoring performed by agents that report data to the controller, identify a performance issue by the server, the performance issue based on the reported data, and automatically perform a cause analysis for performance issues with distributed transactions analyzed by the controller.

22. The system of claim 21, wherein the controller is identified from input received through an interface.

23. The system of claim 21, wherein the agents collect runtime data and provided aggregated data to the controller.

24. The system of claim 21, wherein the modules are further executable to determine a baseline performance level for a portion of a distributed business application and compare performance of the distributed business application portions to the baseline.

25. The system of claim 24, wherein the distributed business transaction portions include an application, a tier, a node, and a method.

26. The system of claim 21, wherein the cause analysis includes a metric analysis of an identified performance issue.

27. The system of claim 21, wherein the cause analysis includes a method analysis of an identified performance issue detected by the controller.

28. The system of claim 21, wherein the cause analysis includes an error analysis of an identified performance issue detected by the controller.

29. The system of claim 21, wherein the cause analysis includes an exit call analysis of an identified performance issue detected by the controller.

30. The system of claim 21, wherein the cause analysis includes a call graph and a snapshot associated with a portion of the distributed business application associated with a selected performance issue.
